(19) United States
(12) Patent Application Publication
(10) Pub. No.: US 2014/0321810 A1
(43) Pub. Date: Oct. 30, 2014

(54) CONNECTOR DETECTION

(71) Applicants: Kevin B. Leigh, Houston, TX (US); George D. Megason, Spring, TX (US)

(72) Inventors: Kevin B. Leigh, Houston, TX (US); George D. Megason, Spring, TX (US)

(21) Appl. No.: 14/366,316

(22) PCT Filed: Jan. 31, 2012
(86) PCT No.: PCT/US2012/023319

§ 371 Date: Jun. 18, 2014

(51) Int. Cl. H01R 13/66; G02B 6/38

(52) U.S. Cl. CPC H01R 13/6683; G02B 6/3895
USPC 385/71; 439/620.21

(57) ABSTRACT

A connector module includes a detection circuit. The connector module may also include an alignment detector. In various examples, the detection circuit is to detect presence of a connector, and the alignment detector is to detect alignment of a plurality of ferrules within the connector module.

### BACKGROUND

A system can include multiple electronic devices. To allow communication with the electronic devices, a backplane infrastructure can be provided in the system, where the backplane infrastructure has connectors to connect with respective mating connectors of the electronic devices. The connectors of the backplane infrastructure can include optical connectors to optically connect to respective electronic devices.

### BRIEF DESCRIPTION OF THE DRAWINGS

Some embodiments are described with respect to the following figures:

FIG. 1 is a schematic perspective view of a backplane including electronic devices connectors according to some implementations;

FIG. 2 is a perspective view of a connector module according to some implementations:

FIG. 3 is a perspective view of a connector module according to some implementations according to some implementations;

FIGS. 4A-B are sectional views of a connector module in accordance with some implementations;

FIGS. 5-6 are now diagrams according to some implementations.

### DETAILED DESCRIPTION

Electronic devices, such as processing devices, storage devices, communications devices, management devices, and so forth, can be mounted in a rack, which includes a frame and other support elements for holding the electronic devices. The rack provides receptacles into which the electronic devices can be inserted. The rack can also include a backplane infrastructure for connection to the electronic devices that have been inserted into the rack. When electronic devices mounted in the rack, connectors on the electronic devices can mate with connectors of the backplane infrastructure. The connectors of the backplane infrastructure are connected to communications media (e.g. optical fibers, electrical wires, etc.) to allow for communication among the electronic devices.

A backplane infrastructure can include optical connectors for optical connection with respective optical connectors of the electronic devices. It is noted that the electronic devices and the connector infrastructure can also include electrical connectors for electrically connecting the electronic devices to the backplane infrastructure. In the ensuing discussion, reference is made to just optical connectors—note, however, that various components discussed below can also include or be substituted with electrical connectors.

In some examples, a backplane infrastructure can include an integrated and fixed arrangement of optical connectors for connection to respective electronic devices. An integrated and fixed arrangement of optical connectors refers to an arrangement in which the optical connectors are affixed to a support structure of the backplane infrastructure such that the optical connectors have to be connected to or disconnected from all electronic devices in a system at the same time. These optical connectors may have multiple ferrules, where each ferrule organizes multiple optical fibers. Generally, a ferrule of an optical connector refers to an interface for an optical fiber, where the interface allows for optical communication between the optical fiber and another optical component. The ferrules can be fixed with the apical connector or alternatively may be removably coupled to the optical connector.

The ability to remove and replace various ferrules may enable access for service (e.g. repair of a component) or upgrade (e.g. replacement of a component), but may also lead to issues. For example, in a system incorporating multiple high density optical connectors each comprising multiple ferrules of multiple optical fibers. Optical fibers are generally positioned in particular manners. If one or more connectors or ferrules are improperly positioned communication errors may occur. Given the multiple connectors and a tendency of slight variances in optical fiber position to produce errors, it may be difficult and time consuming to determine a cause of the error or signal degradation.

In accordance with some implementations, a connector module is provided that incorporates a presence detection circuit configured to detect a presence of a mating connector and an alignment detector configured to detect proper alignment of the connector module with the mating connector. In this manner, a connector module may be able to convey information related to the presence of a mating connector in addition to an indication that various ferrules within the connector module and the mating connector are properly aligned. This provides flexibility to allow a user to quickly determine which connector, if any, is not properly seated or aligned.

In addition, various connector modules may also include identifiers. An identifier is a device or circuit that conveys identification data to a component associated with the mating connector Examples of identification data, which will be discussed in more detail herein, may include number of optical fibers per ferrule, number of ferrules, location of ferrules, or other data associated with associated components. In one example, the identifier may be a radio frequency identification (RFID) device that transmits the identification upon coupling of the connector module with a mating connector.

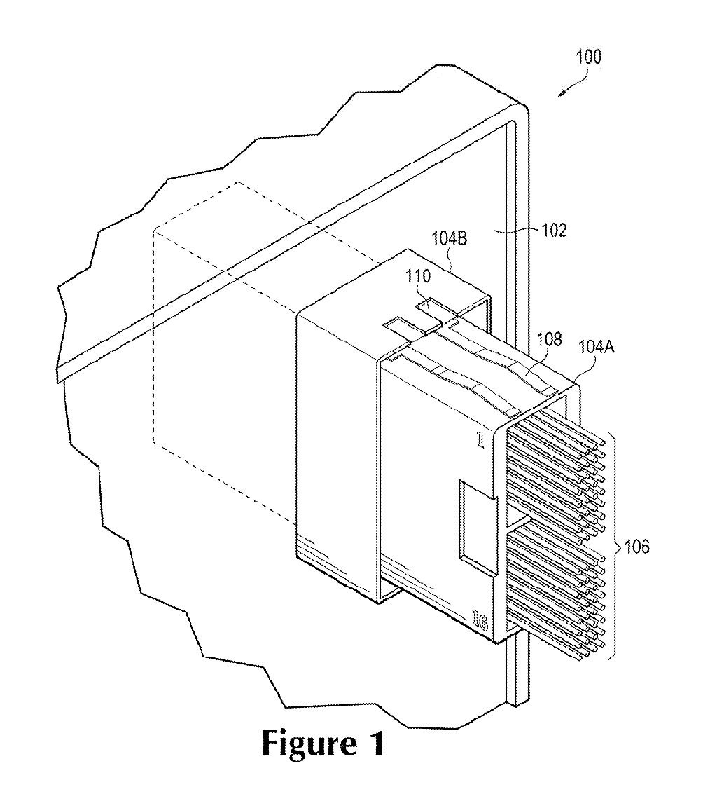

FIG. 1 illustrates an example system 100 that has a backplane infrastructure 102 that includes a connector 104A-B. The backplane infrastructure 102 and connector module having a first housing 104A and a second housing 104B that are configured to mate. The mating may couple various electronic devices (not illustrated) that are inserted into receptacles disposed on a chassis housing the backplane infrastructure 102 to each other and to other devices. The electronic devices may be configured to blind-mate with the backplane infrastructure 102. The connector modules 104A-B, as illustrated, are optical connectors that include multiple ferrules that organize optical fibers 106. In the illustration, sixteen ferrules are utilized, each ferrule organizing four optical fibers 106. More or fewer ferrules which may organize more or fewer optical fibers may also be used. In addition, the connector housings 104A-B include a first presence detection circuit, a second presence detection circuit, and an alignment detector. The first presence detection circuit and the second presence detection circuit, when coupled together, indicate coupling to the first connector housing 104A and the second connector housing 104B, and the alignment detector indicates alignment of the first plurality of ferrules with the second plurality of ferrules. These and other examples will be discussed in more detail herein.

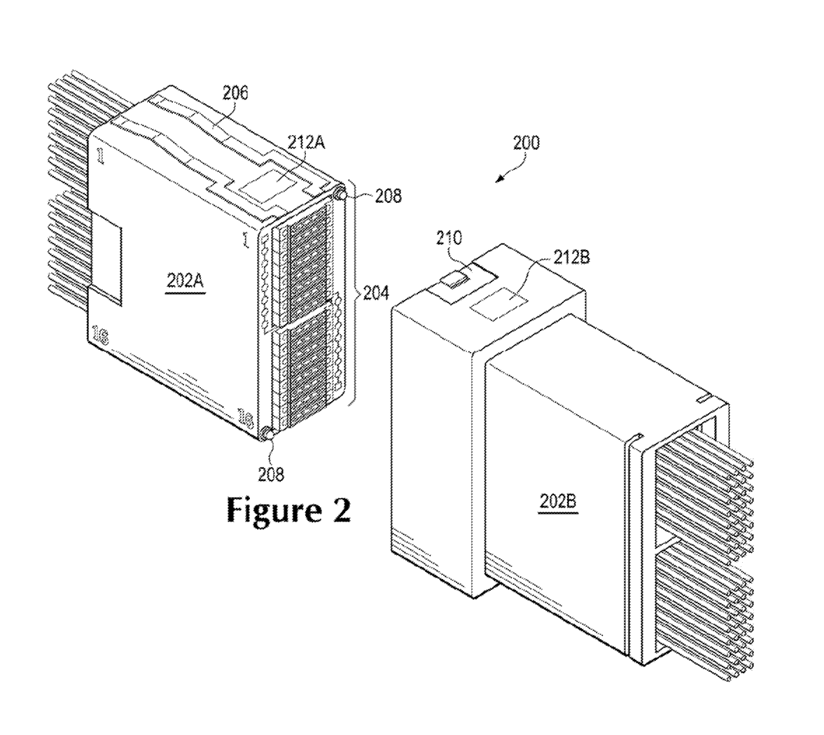

FIG. 2 shows a perspective view of a connector module 200 that has a first connector housing 202A and a second connector housing 202B. A connector housing as used herein describes both a male and female portion of a connector that may house removable and/or non-removable components, for example one or more ferrules. In the illustrated example, both the first connector housing 202A and the second connector housing 202B include a plurality of ferrules that organize optical fibers.

The first connector housing 202A includes a first plurality of ferrules 204, a presence detection circuit 206, and one or more alignment detectors 208. The plurality of ferrules 204 may organize multiple optical fibers for optical communication with optical fibers of the second connector housing 202B. The presence detection circuit 206 may be configured to detect the presence of the second connector housing 202B. For example, in an uncoupled state (as illustrated), the presence detection circuit 206 may have a voltage potential across the two contacts, the voltage potential being provided by an electronic device (not illustrated) coupled to the first connector housing 202A. When in an unmated condition, no current will flow through the presence detection circuit. Alternatively, when mated with the second connector housing 202B, which includes similar disposed contacts 210, the current may flow through the presence detection circuit 206.

In various examples, this current may provide power to various indicators, for example, a light emitting diode (LED), which when powered may provide a visual indication that the first and second connector housings are coupled together. In other examples, the presence detection circuit 206 may be coupled to various controllers which are configured to control various other components, for example a display associated with the system. With multiple connectors having presence detection circuits, a user or computing device, may be configured to quickly determine which connector, if any, out of a plurality of connectors is not present.

In the illustrated example, an alignment detector 208 is to detect proper alignment of the first connector housing 202A with the second connector housing 202B. The alignment detector 208 may provide for electrical or mechanical detection of when the first connector housing 202A and the second connector housing 202B arrive at a predetermined location, for example, when they come into contact with one another. In this manner, the presence detection circuit 206 may provide for a coarse determination of presence, while the alignment detector 208 provides for a granular determination of presence/alignment, for example, fully seated condition.

The alignment aids 208 may be mechanical switches such that when actuated a visual cue may present itself such that a user or computing device may determine that the first and second connector housings 202A-B are properly aligned. Alternatively, the alignment aids 208 may comprise electrical circuits such that contacts may be disposed on both the first and the second connector housings (not shown). The contacts, similar to the presence detection circuit 206 completing a circuit and indicating proper alignment.

As illustrated, the alignment detector 208 is disposed in a corner of a front face of the first connector housing 202A. In other examples, more alignment detectors may be utilized and may be disposed in different locations such that the alignment aid is capable of determining a correct position of the first connector housing 202A relative to the second connector housing 202B.

In addition to the presence detection circuit 206 and the alignment aid 208, the connector module may include an identifier 212A-B to communicate identification data to and from the various connector housings 202A-B. In various examples, the identifier 212A-B may comprise RFID tags, which when brought within a communication distance, are capable of conveying various identification data. In another example, the identifiers 212A-B may comprise non-volatile memory and circuits, which when electrically coupled to each other are capable of conveying information.

The identification data conveyed by the identifiers 212A-B may include information related to a configuration of either the first plurality of ferrules 204, the second plurality of ferrules (not illustrated), a number of ferrules within the first plurality of ferrules 204 or the second plurality of ferrules (not illustrated), a number of optical fibers within each of the plurality of ferrules or other information associated with either the electrical components coupled the first connector housing 202A or the second connector housing 202B, or the connectors housings 202A-B.

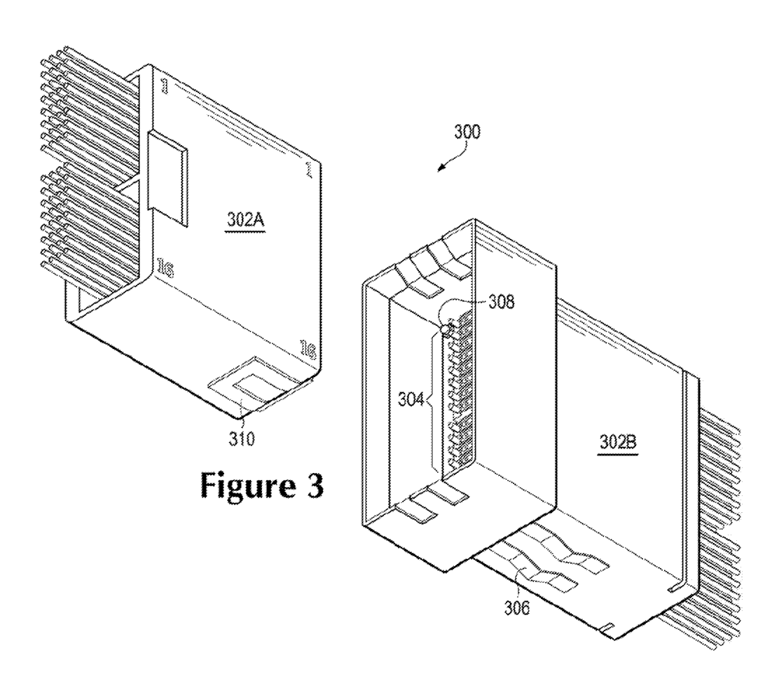

FIG. 3 depicts another connector module 300 generally similar to the connector module 200 of FIG. 2. In addition to the components discussed with reference to FIG. 2, i.e. the presence detection circuit 206 and the alignment detector 208 disposed on the first connector housing 202A, the connector module 300 includes a second presence detection circuit 306 and a second alignment aid 308 disposed on the second connector housing 302B.

Similar to the presence detection circuit 200 of FIG. 2, the presence detection circuit 306 of the second connector housing 302B may be biased with a voltage potential across the open contacts of the second connector housing 302B. When brought into contact with the first connector housing 302A, contacts 310 may effectively close the circuit and allow current to power various components, for example and LED, to indicate to a user or computing component the presence of the first connector housing 302A. When utilized in conjunction with the presence detection circuit 206 of the first connector housing 202A, indications may be available to both the electronic device inserted into the system, i.e., the electronic device inserted into chassis, and to the system itself. This enables a coupling condition to be determined from both device perspective as well as the system perspective.

In addition, an alignment detector 308 may also be similarly disposed within the second connector housing 302B. The alignment aid 308 may consist of, and function, similar to the alignment aid 238 of FIG. 2 The alignment 308 may work in conjunction with the alignment aid 208, or alternatively may operate independent of the alignment aid 208 of FIG. 2. In this manner, and similar to the second presence detection circuit 306, information may be related to both the device and the system into which the device is placed.

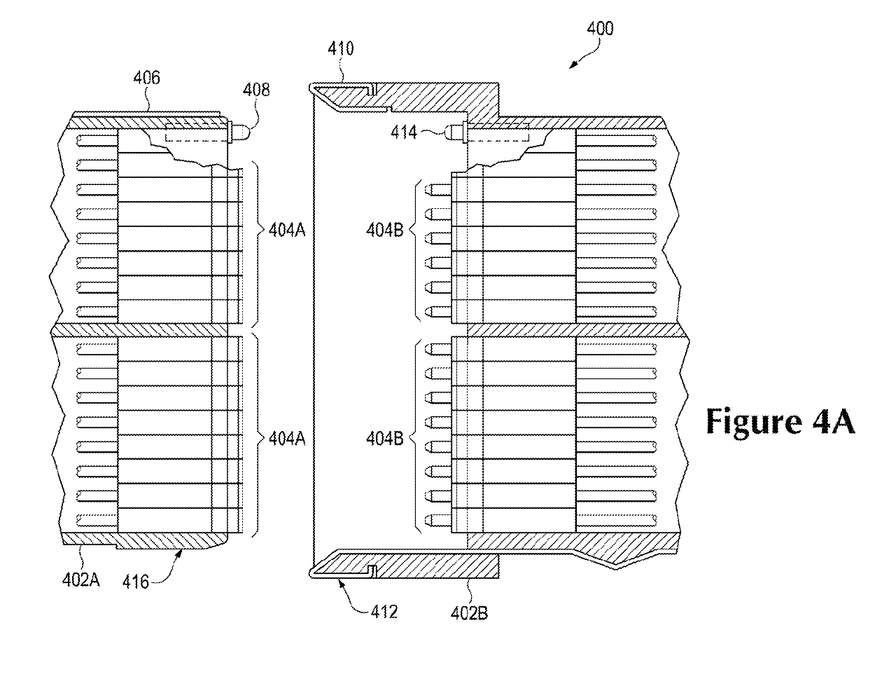

FIGS. 4A-B illustrate sectional views of a connector module in both a mated and unmated condition. In FIG. 4A, the first connector housing 402A is not mated with the second connector housing 402B. The first connector housing 402A includes a first plurality of ferrules 404A, a presence detection circuit 412, an alignment detector 408, and contacts 416. Similarly, the second connector housing 402B includes a plurality of ferrules 404B, a presence detection circuit 412, an alignment detector 414, and contacts 410. The first connector housing 402A is configured to mate with the second connector housing 402B.

Referring to FIG. 4B, the sectional view of the first connector housing 402A mated with the second connector housing 402B is illustrated. In the illustration, the first presence detection circuit 406 is communicatively coupled to the contacts 410. The contacts, as viewed more clearly in FIGS. 2, complete the presence detection circuit 406 enabling a visual indicator or other transmissible signal to indicate to an electronic device (e.g. a blade, a switch, or a system) the presence of the mating connector 402B. Additionally, alignment detector 408 is illustrated as being actuated by similarly disposed alignment detector 414. The actuation of alignment detector 406 may indicate proper alignment of the first plurality of ferrules with the second plurality of ferrules.

In addition, on the second connector housing 402B, the presence detection circuit 412 may be communicatively coupled to the contacts 416 disposed on an upper side of the first connector housing 402A. The contacts, as viewed more clearly FIG. 3, complete the presence detection circuit 412 enabling a visual indicator or other transmissible signal to indicate to a computing device in the rack on the presence of the mating connector 402A of an electronic device (e.g., a blade server, a switch, or a system). Additionally, alignment detector 414 is illustrated as being actuated by similarly disposed alignment detector 408. The actuation of alignment detector 414 may indicate proper alignment of the first plurality of ferrules with the second plurality of ferrules.

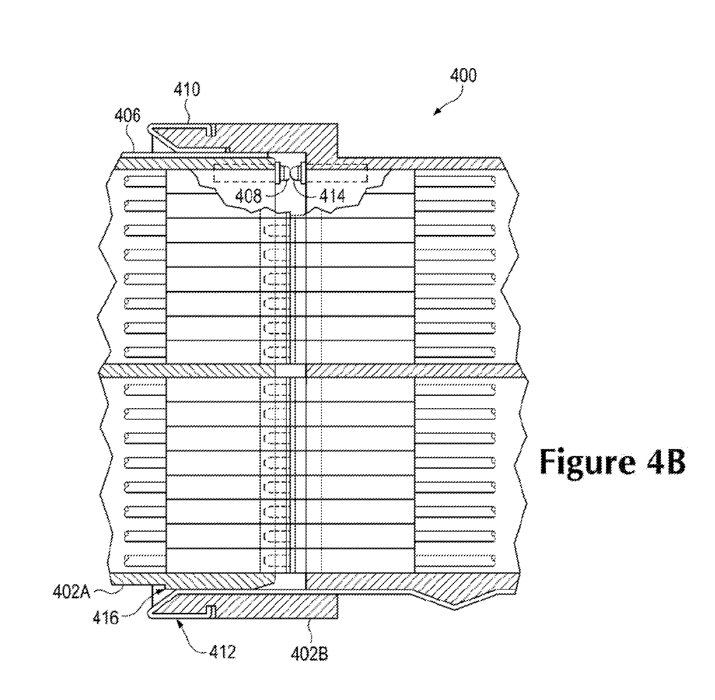

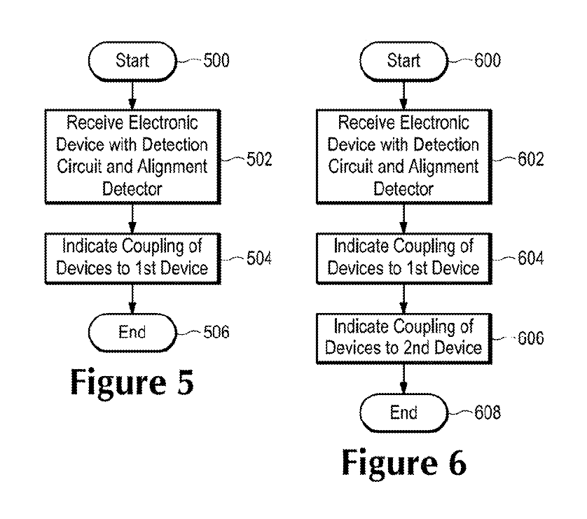

FIGS. 5-6 are flow diagrams according to some implementations. The processes of FIG. 5-6 are merely for illustrative purposes, and are not meant to imply various functions are order dependent. Other processes are contemplated.

The process of FIG. 5 provides (at 502) receiving, by a computing device, an electronic device for optical connection in a rack of the computing device. In various examples, the computing device includes an optical connector including a detection circuit and an alignment detector. Upon receipt of the electronic device, the process indicates at 504) that the electronic device is communicatively coupled to the computing device based on the detection circuit and the alignment detector.

The process of FIG. 6 provides (at 602) receiving, by a computing device, an electronic device for optical connection in a rack of the computing device. In various examples, the computing device includes an optical connector including a detection circuit and an alignment detector. Upon receipt of the electronic device, the process indicates (at 604), to the computing device, that the electronic device is communicatively coupled to the computing device based on the detection circuit and the alignment detector. Additionally, the process indicates (at 606), to the electronic device, that the electronic device is coupled to the computing device based on a detection circuit of the electronic device which is different than the electronic device of the computing device.

In the foregoing description, numerous details are set forth to provide an understanding of the subject disclosed herein. However, implementations may be practiced without some or all of these details. Other implementations may include modifications and variations from the detail discussed above. It is intended that the appended claims cover such modifications and variations.

What is claimed is:

1. A connector module, comprising:
a first connector housing comprising:
a first plurality of ferrules;
a first presence detection circuit; and
an alignment detector;
a second connector housing couplable to the first connector housing, wherein the second connector housing comprises:
a second presence detection circuit, and
a second plurality of ferrules;
wherein the first presence detection circuit and the second presence detection circuit when coupled together indicate coupling to the first connector housing and the second connector housing, and the alignment detector indicates alignment of the first plurality of ferrules with the second plurality of ferrules.

2. The connector module of claim 1, wherein the first plurality of ferrules and the second plurality of ferrules are coupled to fiber optic cables.

3. The connector module of claim 1, wherein the second connector housing further comprises a second alignment detector.

4. The connector module of claim 1, wherein the second connector housing further comprises:
an identifier to communicate identification data to the second connector housing.

5. The connector module of claim 4, wherein the identification data comprises at least one of a configuration of the first plurality of ferrules, a number of ferrules within the first plurality of ferrules, or a number of optical fibers in each of the first plurality of ferrules.

6. The connector module of claim 1, wherein the second connector housing further comprises:
an identifier to communicate identification data the first connector housing.

7. The connector module of claim 6, wherein the identifier comprises a radio-frequency identification (RFID) device.

8. A system comprising;
a backplane including a plurality of back-plane optical connectors each having a plurality of ferrules and a presence detection circuit; and
a plurality of electronic devices removably coupled to the backplane connectors via an electronic device optical connector, wherein each electronic device optical connector includes another plurality of ferrules, another presence detection circuit, and an alignment detector.

9. The system of claim 8, wherein the presence detection circuit indicates the presence of the electronic device optical connector when mated, and the another presence detection circuit indicates the presence of the backplane optical connector when mated.

10. The system of claim 8, wherein each of the backplane optical connectors further includes another alignment detector.

11. The system of claim 10, wherein the alignment detector and the another alignment detector indicate alignment of the plurality of ferrules with the another plurality of ferrules.

12. The system of claim 8, wherein the back-plane optical connectors further include an identifier to communicate identification data to the plurality of electronic devices.

13. The system of claim 8, wherein the electronic device optical connectors further include an identifier to communicate identification data to the back-plane.

14. A method, comprising:
receiving, by a computing device, an electronic device for optical connection in a rack of the computing device, wherein the computing device includes an optical connector including a detection circuit and an alignment detector; and
indicating, by the computing device, the electronic device is communicatively coupled to the computing device based on the detection circuit and the alignment detector.

15. A method of claim 14, further comprising:
Indicating, by the electronic device, the electronic device is communicatively coupled to the computing device based on a detection circuit of the electronic device, the detection circuit of the electronic device being different than the detection circuit of the computing device.
